(19) United States
(12) Patent Application Publication
(10) Pub. No.: US 2004/0012561 A1
(43) Pub. Date: Jan. 22, 2004

(54) Keyboard incorporated with a mouse

(76) Inventor: Frank Zngf, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/198,152

(22) Filed: Jul. 19, 2002

(51) Int. Cl. G09G 5/08

(52) U.S. Cl. 345/157

(57) ABSTRACT

A keyboard incorporated with a mouse for word processors, two separated keyboard parts are used for enabling ten finger typing and a mouse is fastened to one of the keyboard parts which moves along with the mouse in all time while in operation. Each keyboard part includes five multidirectional keys which enable each hand to operate with its five fingers respectively. Each multidirectional key provides nine functions in a three by three matrix pattern. According to the action direction of a finger on a multidirectional key, a function term is selected to input. With such an arrangement, the hand does not need to move between the keyboard and the mouse to operate them alternatively, and the occupancy space of the keyboard with the mouse is reduced tremendously.

### FIELD OF THE INVENTION

The present invention relates to an input device of an information processing system, and more particularly to a combination of a keyboard incorporated with a mouse and the functions of both grouped together as in an apparatus.

### BACKGROUND OF THE INVENTION

A conventional QWERTY format keyboard includes a plurality of keys which are to be operated by the ten fingers of a user. The number of the keys is many more than the number of the fingers of the user, such that each finger has to move among keys as to input desired functions into a computer. A wrong input is incurred if the finger is put on a wrong position. Another disadvantage is that the conventional QWERTY format keyboard is bulky with a large number of the keys that it does not fit to a mini-processor and has troubles to be used in a small space. Furthermore, a keyboard is to be used cooperating with a mouse, a user's hand has to move back and forth between the mouse and the keyboard. The distance between the keyboard and the mouse is about 30 centimeters for a PC system, and about 8 centimeters for a notebook computer, and moves in such distances count for considerable spending time on inputting.

Another fact is that the arrangement of the keys for a PDA or a cellular phone is quite different from that of the QWERTY keyboard for a PC, and that the keys are too small to put on user's fingers to type. Users usually have hard time to adjust to it.

U.S. Pat. No. 5,841,374 discloses a multifunctional key with seven functions for each key and the total number of the keys of the keyboard is nineteen including twelve multifunctional keys, and which is still many more than the number of the user's fingers. In other words, the fingers still have to shift among keys, and the problem regarding to a keyboard working with a mouse is not addressed.

The present invention intends to provide a combination of a keyboard, which enables a user to type without removing fingers from their each respective multidirectional key and also, with no need to move the hand back and forth for operating the keyboard with a mouse. Furthermore, without sacrificing input functions of the keyboard with a mouse, the occupancy of space of the input device is reduced tremendously.

### SUMMARY OF THE INVENTION

In accordance with one aspect of the present invention, a combination of a keyboard incorporated with a mouse is provided wherein the keyboard which has a first part and a second part, both of which are connected to a computer. A mouse is fixed to the second part so that the mouse and the second part of the keyboard can move along at all time while the user inputs.

Each of the first part and the second part of the keyboard has five multidirectional keys and each of the multidirectional keys will be operated by each of the fingers of a user. Each of the multidirectional keys has nine functions arranged in a three by three matrix pattern. An embodiment of the multidirectional key is introduced in this invention. The embodiment uses a two dimensional tilt sensor for generating a vector of a 2D tilt angle, and the vector is classified by direction ranges as one of eight peripheral function terms. Additionally, a pressure sensor is used for generating the central pushdown function of the three by three pattern of the multidirectional key.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the connection of the two-part keyboard, the mouse and the computer;

FIG. 2 shows the arrangement of the five multidirectional keys on each of two parts of the keyboard;

FIG. 3 shows the mouse connected to one of the two parts of the keyboard; and

FIG. 4 shows an embodiment of a multidirectional key which includes a two-dimensional tilt sensor and a pressure sensor.

### DETAILED DESCRIPTION OF THE PREFERRED EMBODIMENT

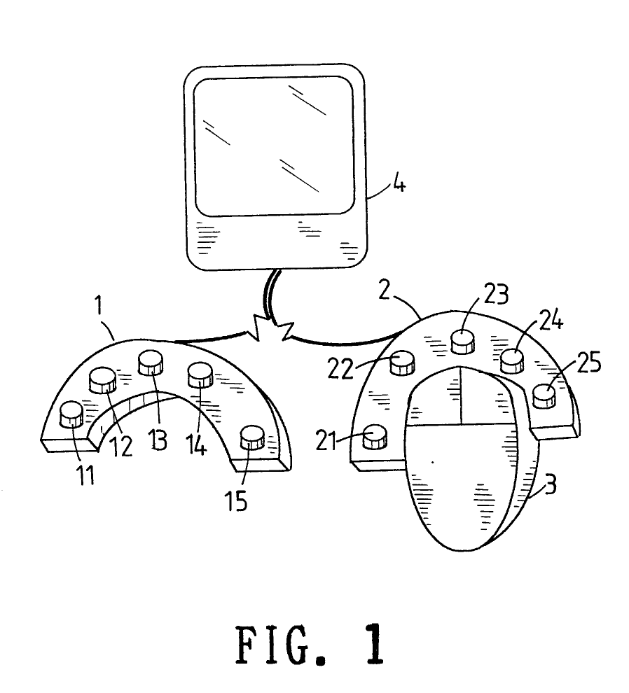

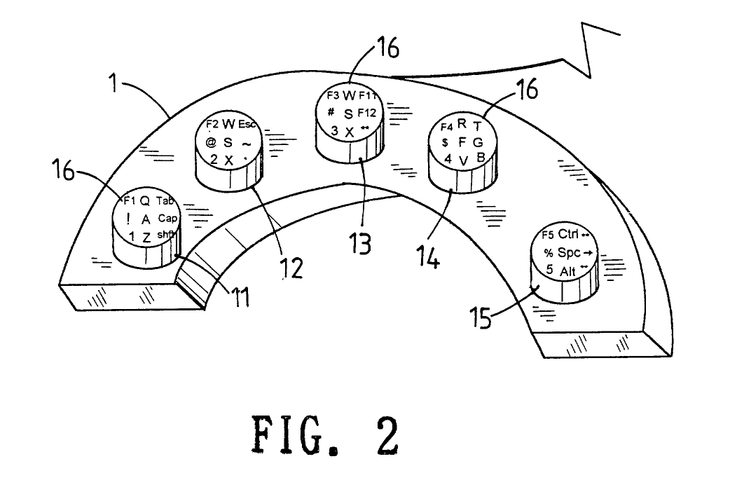

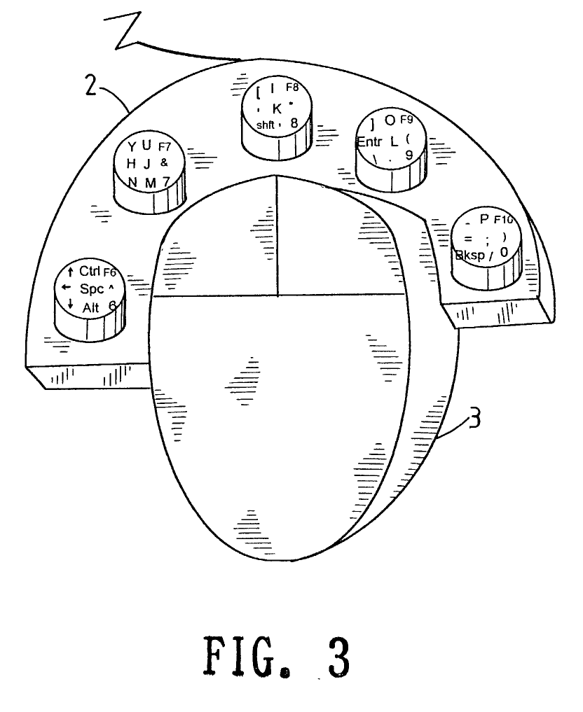

Referring to FIGS. 1 to 3, the keyboard of the present invention comprises a first part 1 and a second part 2 and both of which are connected to a computer 4. Each of the first part 1 and the second part 2 has five multidirectional keys 11-15, and 21-25 so that each finger of a user operates a specific multidirectional key. A mouse 3 is used to incorporate with the keyboard, of which the second part 2 is fastened to the front end of the mouse 3.

Each of the multidirectional keys includes nine functions arranged in a three by three matrix pattern, and nine function codes 16 are marked on each of the multidirectional keys. Each of the nine functions can be input into the computer 4 specifically by operating the multidirectional key with a finger. The total number of the functions is ninety and is able to include all the functions of a QWERTY format keyboard. The positions of the nine function codes are located similar to that on the QWERTY keyboard and users may quickly be adapted to the corresponding operations.

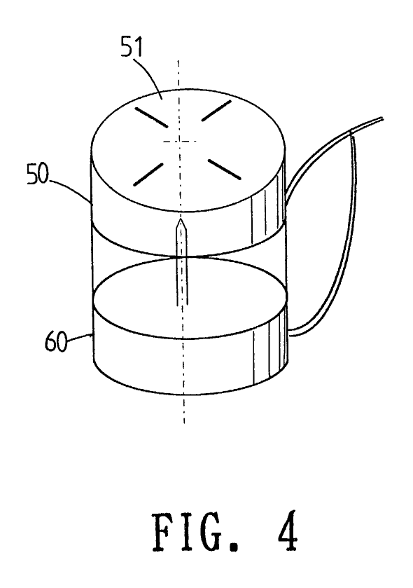

Referring to FIG. 4, an embodiment of a multidirectional key includes a two-dimensional tilt sensor 50, a pressure sensor 60 and a vector classification unit which can be a computer program to classify a vector into one of multiple directional classes. A pole 52 and a soft support 53 such as a sponge are used as auxiliary elements to support the tilt sensor 50 and to make it possible for applying a tilting action with a finger. When the tilt sensor 50 senses two component tilt angles in two directions, produced by a finger enacting on the multidirectional key, as a vector with two elements, the vector is classified into one of eight directional classes in a two dimensional space. The eight directional classes each corresponds to a function marked peripherally in a multi-directional key. When the value of a directional vector is higher than a pre-set value, a corresponding function term is chosen and input into the computer 4. The ninth function, marked at the center in the multi-directional key, is detected by the pressure sensor 60 which senses a downward pressure and activates a corresponding function to be input into the computer 4.

In order to assist the user's finger to correctly apply a tilting action, four ridges 51 extend in a radial form on the top surface of each multidirectional key. The ridges make it easier for users to sense the differences between directions parallel to X and Y axes and directions in diagonals. Two ways are suggested to apply a two-dimensional tilting action on the tilt sensor of a multi-directional key. One way is to shift the fingertip a short distance from the center of the sensor along a particular direction and to push downward, then a 2D tilt angle will be generated. Another way is to keep a fingertip in close contact with the top surface of the tilt sensor and to tilt the sensor just by finger inclination without displacing the fingertip.

While we have shown and described the embodiment in accordance with the present invention, it should be clear to those skilled in the art that further embodiments may be made without departing from the scope of the present invention.

What is claimed is:

1. A combination of mouse and keyboard for a computer comprising:
a keyboard which includes a first part and a second part both of which are connected to a computer, each of the first part and the second part including five multidirectional keys, and
a mouse fixed to the second part, such that the second part is able to be moved along with the mouse.

2. A combination of keys and keyboard arrangement for a computer comprising:
a keyboard adapted to be connected with a computer and having a plurality of multidirectional keys, each multidirectional key having a two dimensional tilt sensor which is adapted to detect the angle vector falling within one of multiple direction ranges for the tilting action applied by a finger tip on the key to select and activate a specific function term for input.

3. The combination as claimed in claim 1 and 2, wherein each of the multidirectional keys includes nine functions arranged in a three by three matrix pattern.

4. The combination as claimed in claim 1, 2 and 3, wherein each of the multidirectional keys includes a two-dimensional tilt sensor, a pressure sensor and a vector classification unit.

5. The combination as claimed in claim 4 wherein the two-dimensional tilt sensor senses a tilting vector applied on the multidirectional key.

6. The combination as claimed in claim 4 wherein the pressure sensor senses a downward pressure applied on the multidirectional key.

7. The combination as claimed in claim 4 wherein the vector classification unit classifies a tilting vector as either one of eight horizontal directions or a downward pressure as a downward direction, and each direction represents a specific function term for input.
